(19) United States
(12) Patent Application Publication
(10) Pub. No.: US 2025/0330921 A1
(43) Pub. Date: Oct. 23, 2025

(54) METHOD AND APPARATUS FOR PROVIDING SYNCHRONIZATION IN WIRELESS COMMUNICATION SYSTEM

(71) Applicant: Samsung Electronics Co., Ltd., Suwon-si, Gyeonggi-do (KR)

(72) Inventor: Sangjun MOON, Suwon-si (KR)

(21) Appl. No.: 18/698,593

(22) PCT Filed: Oct. 6, 2022
(86) PCT No.: PCT/KR2022/015054

§ 371 Date: Sep. 18, 2024

(30) Foreign Application Priority Data
Oct. 8, 2021 (KR) 10-2021-0134460

(51) Int. Cl. H04W 56/00; H04W 48/18

(52) U.S. Cl. CPC H04W 56/001; H04W 48/18

(57) ABSTRACT

According to a method of operating a time sensitive communication time synchronization function (TSCTSF) for providing synchronization in a wireless communication system, the TSCTSF receives a request for time synchronization associated with a non-access stratum (NAS) from an application function (AF), and transmit access stratum (AS) based time synchronization information to a base station through a policy control function (PCF) based on the request for time synchronization associated with the NAS.

### TECHNICAL FIELD

The disclosure relates to a method and apparatus for providing synchronization in a wireless communication system.

### BACKGROUND ART

To meet the demand with respect to ever-increasing wireless data traffic since the commercialization of the 4th generation (4G) communication system, there have been efforts to develop an advanced 5th generation (5G) or pre-5G communication system. For this reason, the 5G or pre-5G communication system is also referred to as a beyond fourth generation (4G) network communication system or post long-term evolution (LTE) system. Implementation of the 5G communication system using ultrahigh frequency (millimeter wave (mmWave)) bands, e.g., 60 giga hertz (GHz) bands, is being considered to attain higher data transfer rates. To reduce propagation loss of radio waves and increase a transmission range of radio waves in the ultrahigh frequency bands, beamforming, massive multiple-input multiple-output (MIMO), full dimensional MIMO (FD-MIMO), array antenna, analog beamforming, and large-scale antenna techniques are under discussion. To improve system networks, technologies for advanced small cells, cloud radio access networks (RANs), ultra-dense networks, device to device (D2D) communication, wireless backhaul, moving networks, cooperative communication, coordinated (CoMP), reception-end interference cancellation and the like are also being developed in the 5G communication system. In addition, in the 5G system, an advanced coding modulation (ACM), e.g., hybrid FSK and QAM modulation (FQAM), sliding window superposition coding (SWSC), and an advanced access technology, e.g., filter bank multi carrier (FBMC), non-orthogonal multiple access (NOMA), and sparse code multiple access (SCMA) are being developed.

In the meantime, the Internet is evolving from a human-oriented connectivity network where humans create and consume information to an Internet of things (IoT) network where distributed entities or things send, receive and process information without human intervention. Internet of Everything (IoE) technologies, in which a big data processing technology through connection with a cloud server, for example, are combined with an IoT technology, have also emerged. To implement IoT, various technologies, such as a sensing technology, a wired/wireless communication and network infrastructure, a service interfacing technology, and a security technology are required, and even technologies for sensor networks, machine to machine (M2M) communication, machine type communication (MTC) for connection between things are being studied these days. In the IoT environment, intelligent information technology (IT) services that create new values for human life by collecting and analyzing data generated from connected things may be provided. IoT may be applied to a variety of areas, such as smart homes, smart buildings, smart cities, smart cars or connected cars, smart grids, health care, smart home appliances and advanced medical services through convergence and combination between existing IT technologies and various industrial applications.

In this regard, various attempts to apply the 5G communication system to the IoT network are being made. For example, technologies regarding sensor network, M2M, MTC, etc., are implemented by the 5G communication technologies, such as beamforming, MIMO, array antenna schemes, etc. Even application of a cloud radio access network (cloud RAN) as the aforementioned big data processing technology may be an example of convergence of 5G and IoT technologies.

With the development of the aforementioned wireless communication systems, it is possible to provide various services, and there is a need for a method to provide the services smoothly.

### DISCLOSURE

### Technical Problem

The disclosure provides an apparatus and method for effectively providing a service in a wireless communication system.

### Technical Solution

According to an embodiment of the disclosure, a method of operating a time sensitive communication time synchronization function (TSCTSF) for providing synchronization in a wireless communication system may include: receiving a request for time synchronization associated with a non-access stratum (NAS) from an application function (AF); and transmitting access stratum (AS) based time synchronization information to a base station (BS) through a policy control function (PCF) based on the request for time synchronization associated with the NAS.

According to an embodiment of the disclosure, a TSCTSF for providing synchronization in a wireless communication system may include: a transceiver; and at least one processor coupled with the transceiver. The at least one processor may be configured to receive a request for time synchronization associated with an NAS from an AF, and transmit AS based time synchronization information to a BS through a PCF based on the request for time synchronization associated with the NAS.

According to an embodiment of the disclosure, a method of operating a PCF for providing synchronization in a wireless communication system may include: receiving, from a TSCTSF, AS based time synchronization information obtained based on a request for time synchronization associated with an NAS; and transmitting information about a third synchronization error budget based on the AS based time synchronization information to a BS through an access and mobility management function (AMF). The AS based time synchronization information may be obtained based on the request for time synchronization associated with the NAS.

A PCF for providing synchronization in a wireless communication system may include: a transceiver; and at least one processor coupled with the transceiver. The at least one processor may be configured to receive AS based time synchronization information obtained based on a request for time synchronization associated with an NAS from a TSCTSF, and transmit information about a third synchronization error budget based on the AS based time synchronization information to a BS through an AMF. The AS based time synchronization information may be obtained based on the request for time synchronization associated with the NAS.

### DESCRIPTION OF DRAWINGS

FIG. 1 is a diagram for describing a principle of time synchronization in Ethernet of a time sensitive network (TSN).

FIG. 2 illustrates a scenario for supporting TSN time synchronization of a 5th generation (5G) network.

FIG. 3 illustrates a method for a 5G network to support TSN time synchronization.

FIG. 4A illustrates an example in which all terminals are 5G user equipments (UEs)/device-side TSN translators (DS-TTs) for supporting a video imaging audio professional application (VIAPA) that is able to generate a sync message based on a 5G system (5GS) clock and provide the sync message to the outside, according to an embodiment of the disclosure.

FIG. 4B illustrates an example in which some terminals are 5G UEs/DS-TTs for supporting a VIAPA that is able to generate a sync message based on a 5GS clock and provide the sync message to the outside, according to an embodiment of the disclosure.

FIG. 5 illustrates a configuration method for a 5GS to be a synchronization source, according to an embodiment of the disclosure.

FIG. 6 is a sequence diagram illustrating a method for a time sensitive communication time synchronization function (TSCTSF)/network exposure function (NEF) to switch and send an application function (AF) request into an access stratum (AS) basis to suit a 5GS situation, according to an embodiment of the disclosure.

FIG. 7 is a sequence diagram illustrating a method for a TSCTSF/NEF to switch and send an AF request into a non-access stratum (NAS) basis to suit a 5GS situation, according to an embodiment of the disclosure.

FIG. 8 is a sequence diagram illustrating a method for a TSCTSF/NEF to switch and send an AF request into an AS and NAS basis to suit a 5GS situation, according to an embodiment of the disclosure.

FIG. 9 is a sequence diagram illustrating a method for an AF to see a 5GS situation and perform delivery by switching into an AS basis to suit the 5GS situation, according to an embodiment of the disclosure.

FIG. 10 is a sequence diagram illustrating a method for an AF to see a 5GS situation and perform delivery by switching into an NAS basis to suit the 5GS situation, according to an embodiment of the disclosure.

FIG. 11 is a sequence diagram illustrating a method for an AF to see a 5GS situation and perform delivery by switching into an AS and NAS basis to suit the 5GS situation.

FIG. 12 is a block diagram illustrating a configuration of a UE, according to an embodiment of the disclosure.

FIG. 13 is a block diagram illustrating a configuration of a base station (BS), according to an embodiment of the disclosure.

FIG. 14 is a block diagram illustrating a configuration of a core network entity in a wireless communication system, according to an embodiment of the disclosure.

### MODE FOR INVENTION

Embodiments of the disclosure will now be described in detail with reference to accompanying drawings. In the description of the disclosure, when it is determined that a detailed description of associated commonly-used technologies or structures may unnecessarily obscure the subject matter of the disclosure, the detailed description will be omitted. Further, the terms, as will be mentioned later, are defined by taking functionalities in the disclosure into account, but may vary depending on practices or intentions of users or operators. Accordingly, the terms should be defined based on descriptions throughout this specification.

Advantages and features of the disclosure, and methods for attaining them will be understood more clearly with reference to the following embodiments of the disclosure, which will be described in detail later along with the accompanying drawings. The embodiments of the disclosure may, however, be embodied in many different forms and should not be construed as limited to the embodiments set forth herein; rather, these embodiments of the disclosure are provided so that this disclosure will be thorough and complete, and will fully convey the scope of the embodiments of the disclosure to those of ordinary skill in the art. Like numbers refer to like elements throughout the specification.

It will be understood that each block and combination of the blocks of a flowchart may be performed by computer program instructions. The computer program instructions may be loaded onto a processor of a universal computer, a special-purpose computer, or other programmable data processing equipment, and thus they generate means for performing functions described in the block(s) of the flowcharts when executed by the processor of the computer or other programmable data processing equipment. The computer program instructions may also be stored in computer-executable or computer-readable memory that may direct the computers or other programmable data processing apparatus to function in a particular manner, such that the instructions stored in the computer-executable or computer-readable memory may produce an article of manufacture including instruction means that perform the functions specified in the flowchart blocks(s). The computer program instructions may also be loaded onto the computer or other programmable data processing apparatus to cause a series of operational steps to be performed on the computer or other programmable apparatus to produce a computer implemented process such that the instructions that are executed on the computer or other programmable apparatus provide operations for implementing the functions specified in the flowchart block(s).

Furthermore, each block may represent a part of a module, segment, or code including one or more executable instructions to perform particular logic function(s). It is noted that the functions described in the blocks may occur out of order in some alternative embodiments. For example, two successive blocks may be performed substantially at the same time or in reverse order depending on the corresponding functions.

The term “module” (or sometimes “unit”) as used herein refers to a software or hardware component, such as field programmable gate array (FPGA) or application specific integrated circuit (ASIC), which performs some functions. However, the module is not limited to software or hardware. The module may be configured to be stored in an addressable storage medium, or to execute one or more processors. For example, the modules may include components, such as software components, object-oriented software components, class components and task components, processes, functions, attributes, procedures, subroutines, segments of program codes, drivers, firmware, microcodes, circuits, data, databases, data structures, tables, arrays, and variables. Functions served by components and modules may be combined into a small number of components and modules, or further divided into a larger number of components and modules. Moreover, the components and modules may be implemented to execute one or more central processing units (CPUs) in a device or security multimedia card. In embodiments of the disclosure, the module may include one or more processors.

In the descriptions of the disclosure, detailed explanations of the related art are omitted when it is deemed that they may unnecessarily obscure the essence of the disclosure. Embodiments of the disclosure will now be described with reference to accompanying drawings.

Herein, terms to identify access nodes, terms to refer to network entities, terms to refer to messages, terms to refer to interfaces among network entities, terms to refer to various types of identification information, etc., are examples for convenience of explanation. Accordingly, the disclosure is not limited to the terms as herein used, and may use different terms to refer to the items having the same meaning in a technological sense.

In the following description, for convenience of explanation, terms and definitions used in the most recent standards among the currently existing communication standards, i.e., in the 5th generation system (5GS) and new radio (NR) standard defined in the 3rd Generation Partnership Project (3GPP) will be used. The disclosure is not, however, limited to the terms and definitions, and may be equally applied to wireless communication networks that conform to other standards. Especially, the disclosure may be applied to the 3GPP 5GS/NR (which is the 5G mobile communication standard).

The disclosure relates to an advance request method for 5GS synchronization, and to 5GS synchronization exposure for a future protocol data unit (PDU) session.

The disclosure relates to a method of providing time synchronization between wireless terminals (or UEs) connected or to be connected to a 5GS by expanding a function of supporting a time sensitive network (TSN) to a wireless communication network, specifically, a 3GPP 5GS.

In an embodiment, when a 3GPP network (e.g., a 5GS) becomes a synchronization source and a network-side TSN translator (NW-TT) or a device-side TSN translator (DS-TT) generates and sends a generalized precision time protocol ((g)PTP) message to an external wireless node, it may cause a problem having to determine whether to send the (g)PTP message even into the 3GPP network (e.g., 5GS) or how to send a request.

The disclosure may reduce unnecessary (g)PTP message traffic occurrences in the 5GS, thereby reducing UE/network loads and consumption of UE current. Furthermore, in the disclosure, concerns about wrong designation of a future UE may be reduced. Moreover, in an embodiment of the disclosure, 5GS sync may be provided even to an application that does not support the TSN such as a video imaging audio professional application (VIAPA). Especially, various clock sync requested environments may be supported by providing clock sync to a different domain for each DS-TT port and each NW-TT and thus providing sync with a sync precision and an individual sync message type. For example, it is also possible for the 5GS to provide 1 μs sync for factory automation between wired networks and 100 μs sync for audio services between wireless terminals.

Time synchronization for associated nodes is required to support such a scenario as factory automation. In a situation requiring precision work in particular, precision of the time synchronization needs to be high as well. In a case of using Ethernet for industrial use, a time sensitive networking (TSN) technology as a method of supporting time synchronization between nodes connected in the Ethernet has been researched, commercialized and used.

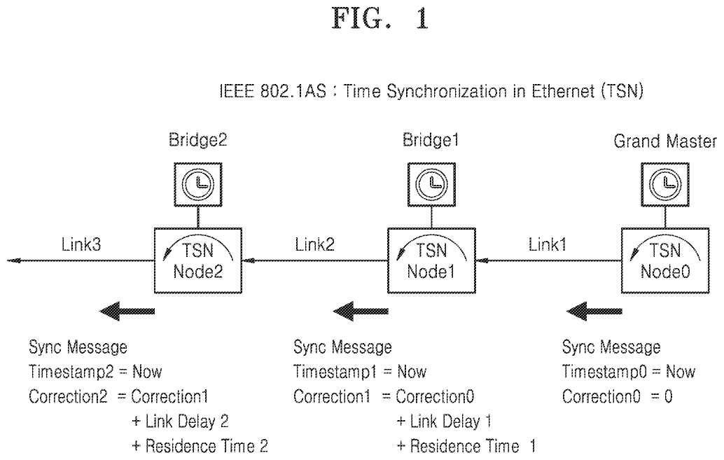

FIG. 1 is a diagram for describing a principle of time synchronization in Ethernet of a TSN. Nodes of the TSN set a grand master (GM) as a reference, and TSN Node0 connected to the GM may generate a sync frame by putting a current time of the GM into a timestamp field and filling a correction field with ‘0’ and transmit the sync frame to a next node. The next node, TSN Node1 may receive the sync frame that has undergone Link Delay 1, update the correction field by taking into account even Residence Time 1 that is a time for which the sync frame stays in the node itself, and transmit the sync frame to a next node. The next node, TSN Node2 may receive the sync frame that has undergone Link Delay 2, update the correction field by taking into account even Residence Time 2 that is a time for which the sync frame stays in the node itself, and transmit the sync frame to a next node. Each node may measure a timing advance for the link to a previous node periodically, and calculate and manage an average timing advance. Furthermore, the node may have how to calculate the residence time in the node itself. In an embodiment, a sync message of FIG. 1 may refer to a sync frame.

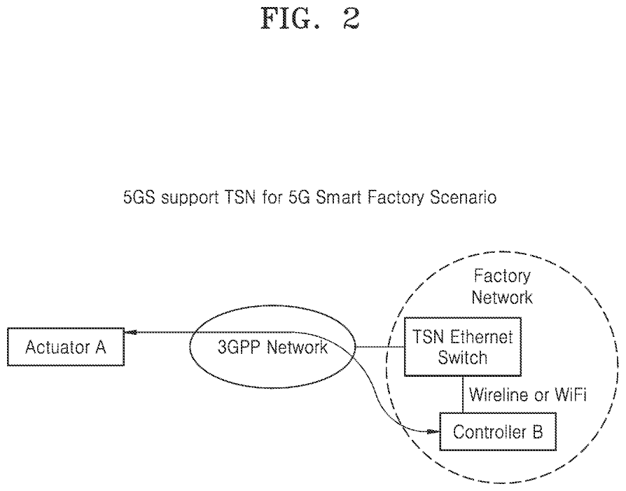

FIG. 2 illustrates a scenario for supporting TSN time synchronization of a 5G network.

Referring to FIG. 2, illustrated is a factory automation scenario that supports mobility by applying a 5G network. In such a case of FIG. 2, the 5G network may need to support a TSN.

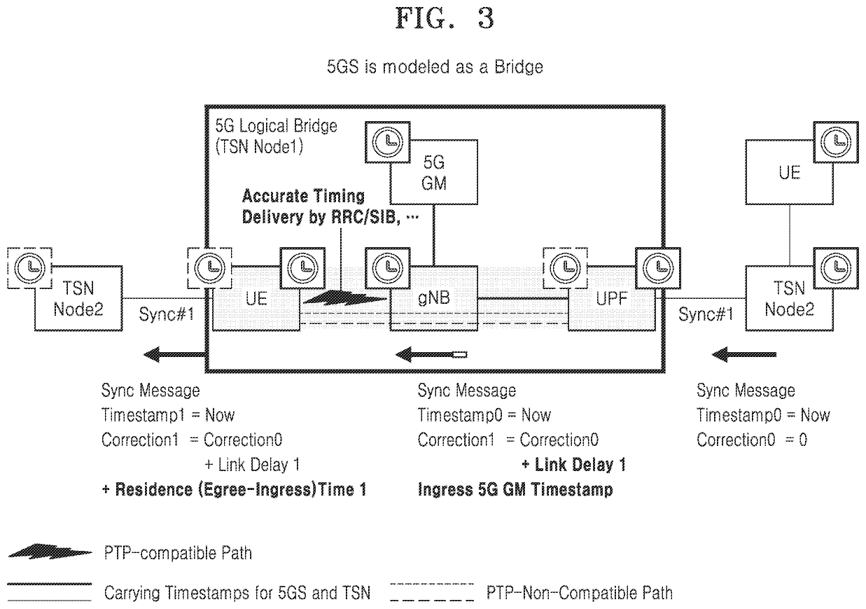

FIG. 3 illustrates a method for a 5G network to support TSN time synchronization.

FIG. 3 is about a method for the 5G network to support a TSN in such a situation as in FIG. 2, and models the 5G network as one TSN bridge (a TSN node) of FIG. 1. Specifically, referring to FIG. 3, the 5G network, user plane function (UPF)-gNB-user equipment (UE) is one TSN node, which may support the TSN by updating the sync frame by correcting Link Delay and Residence Time. For this, the UPF, the gNB (or BS) and the UE in the 5G network may be assumed to be in sync with the common 5G GM. For example, the gNB may be connected to a global positioning system (GPS), the UPF may be connected to the gNB through an Ethernet-based TSN to synchronize with the gNB, and the UE may synchronize with the gNB through a procedure for exchanging a PHY frame. The UPF may be connected to a TSN node of a wired network and the UE may also be connected to a TSN node of a wired network. FIG. 3 corresponds to a situation where there is a GM of the TSN in the TSN node connected to the UPF, and the UPF receives a sync frame from the previous TSN node. The UPF may record a 5G GM based time of the received sync frame, as an ingress time. The UPF may periodically calculate and manage link delay with the previous TSN node. The UPF may send a sync frame including the ingress time and the link delay to the UE. The UE may calculate a residence time in the 5G network based on the 5G GM based time which is a time in an instant when the sync frame is transmitted to the next TSN node. The UE may update the correction field by using the residence time and the link delay and transmit the sync frame to the next TSN node.

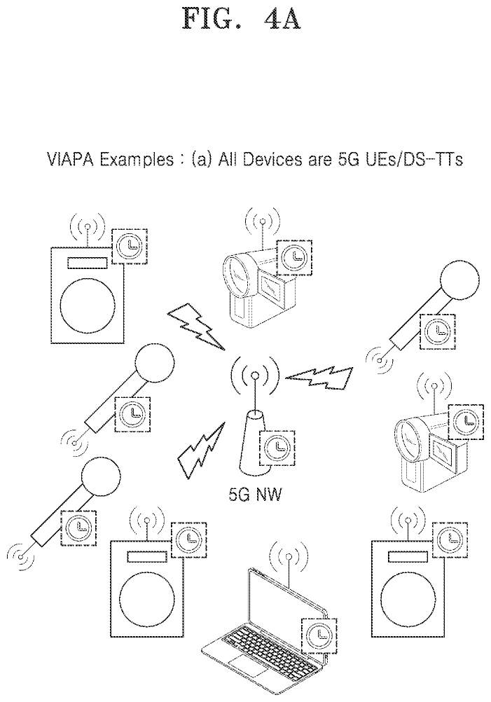

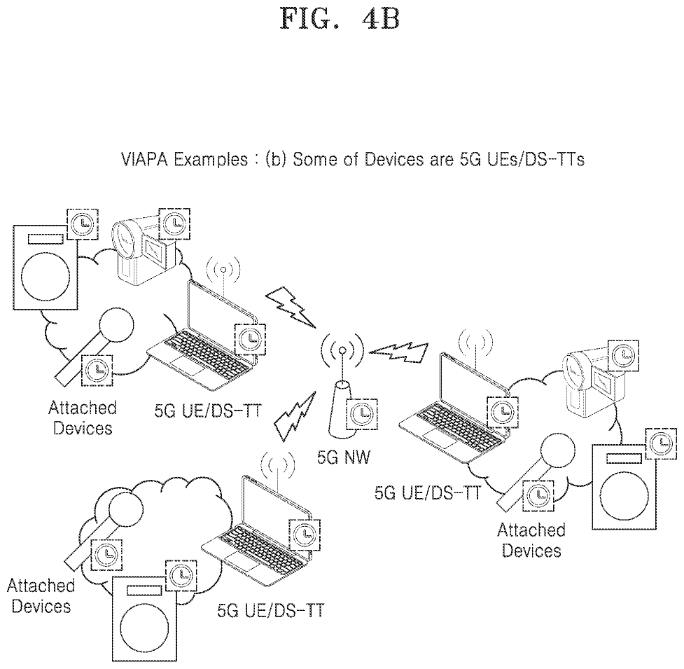

FIG. 4A illustrates an example in which all terminals are 5G UEs/DS-TTs for supporting a video imaging audio professional application (VIAPA) that is able to generate a sync message based on a 5G clock and provide the sync message to the outside, according to an embodiment of the disclosure.

Referring to FIG. 4A, devices used for an on-site performance such as a camera, a microphone, a speaker, a mixing system, etc., may be 5G UEs/DS-TTs, which may maintain in clock sync between them by receiving a sync message from a 5G network. This may enable harmonious performance by controlling a creation time of each video clip/sound/image, etc.

FIG. 4B illustrates an example in which some terminals are 5G UEs/DS-TTs for supporting a VIAPA that is able to generate a sync message based on a 5GS clock and provide the sync message to the outside, according to an embodiment of the disclosure.

Referring to FIG. 4B, a mixing system may be a 5G UE/DS-TT, and a camera, a microphone, a speaker, etc., may be connected to a nearby mixing system. As the mixing systems are 5G UEs/DS-TTs, they may maintain in clock sync between them by receiving a sync message from a 5G network. The camera, the microphone, the speaker, etc., may maintain in clock sync between them by receiving a sync message from the nearby mixing system. This may enable harmonious performance by controlling a creation time of each video clip/sound/image, etc.

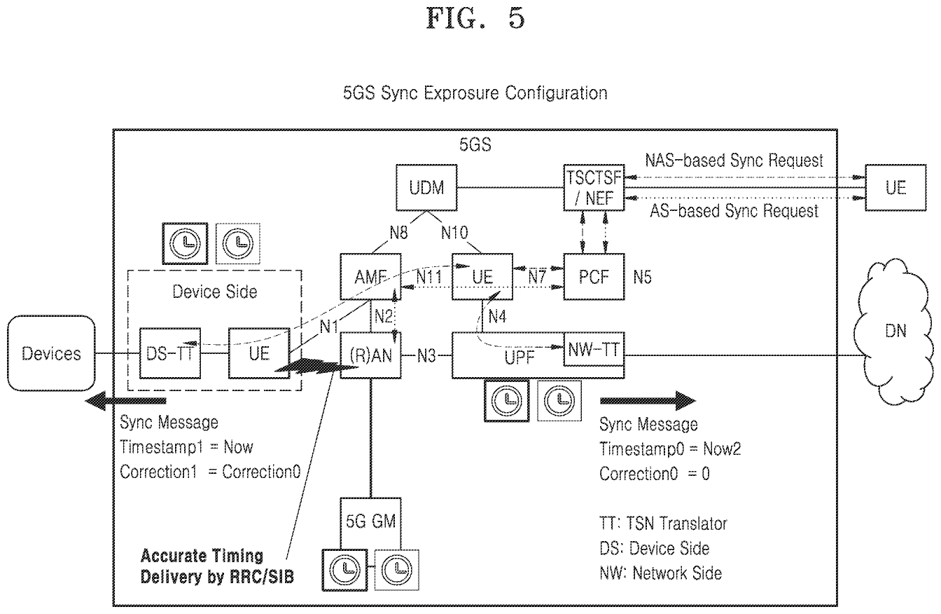

FIG. 5 illustrates a configuration method for a 5GS to be a synchronization source, according to an embodiment of the disclosure.

Referring to FIG. 5, in a case that a 5GS links to a TSN system, a TSN AF may cooperate and exchange management information with a centralized network configuration (CNC) server. The TSN AF may read management information from an NW-TT and a DS-TT, or change a configuration by delivering management information to the NW-TT and the DS-TT.

In an embodiment, in a case that there is no TSN AF, the 5GS may link to an external application function (AF) through a time sensitive communication time synchronization function (TSCTSF)/network exposure function (NEF). In this case, the TSCTSF/NEF may perform a similar function to that performed by the TSN AF. The NEF may exchange management information with the NW-TT and the DS-TT. Furthermore, the NEF may link to a session management function (SMF), an access and mobility management (AMF), a policy control function (PCF), UDR, etc., to deliver information of the 5GS to the external AF or apply a requirement of the external AF to the 5GS system. Especially, the NEF may deliver updated information to the unified data management (UDM)/user data repository (UDR) or the policy control function (PCF) through a notification procedure while storing necessary information in the UDR. The aforementioned method may be referred to as an NAS based method.

In an embodiment, time synchronization between terminals may be supported by delivering a request of the AF to an applied 5G radio access network (RAN) and controlling radio resource control (RRC) or a system information block (SIB). FIG. 5 illustrates a procedure for controlling a RAN sync function by using a RAN parameter. The aforementioned method may be referred to as an AS based method. In an embodiment, transmission frequency of radio resource control (RRC)/system information block (SIB) to deliver the time information may increase to an extent that satisfies the accuracy. The BS may control periodicity of exchanging messages for measuring a timing advance between a particular terminal and the BS by RRC. By controlling the periodicity, a precise timing advance may be measured, thereby controlling time sync accuracy. Furthermore, the BS may control the delivery periodicity by adding time information to information to be broadcast to all UEs in SIBs. Through this periodicity control, time sync accuracy may be controlled.

In an embodiment, a request of the AF may include at least one of an NAS based request or an AS based request. However, the AF may not know of internal status information of the 5GS such as supportable sync accuracy, the number of associated UEs, whether the UE is idle or active, etc. Hence, even though the AF sends an NAS based request, the 5GS sync may need to be handled on an AS basis. Alternatively, even though the AF sends an AS based request, the 5GS sync may need to be handled on an NAS basis. Alternatively, even though the AF sends an NAS or AS based request, both the AS based 5GS sync and the NAS based 5GS sync may need to be handled.

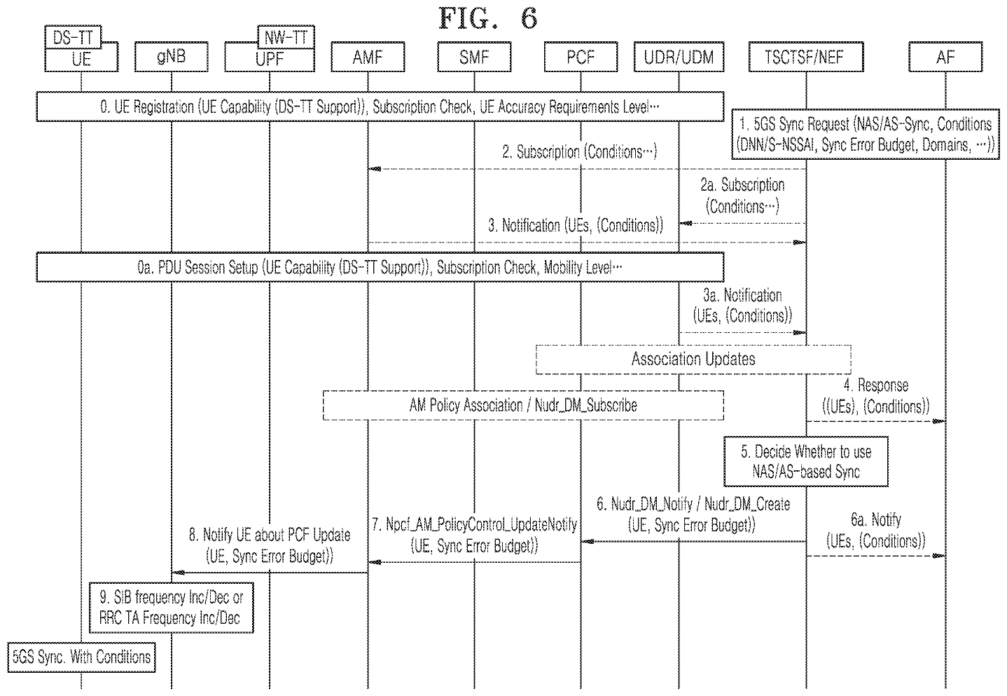

FIG. 6 is a sequence diagram illustrating a method for a TSCTSF/NEF to change and send an AF request into an AS basis to suit a 5GS situation, according to an embodiment of the disclosure.

Referring to FIG. 6, in operation 0, a UE may make registration, with information about whether to support a DS-TT, 5GS synchronization service subscription information, requirement accuracy information, UE mobility information, and the like. In this procedure, the information may be stored in an AMF and a UDM.

Furthermore, in operation 0, in setting up a PDU session, whether to support a DS-TT (e.g., DS-TT support), 5GS synchronization service subscription information (e.g., subscription check), UE mobility information, etc., may be included.

In operation 1, an AF may send a 5GS sync request to a TSCTSF through an NEF. In this case, it may be on an NAS basis or an AS basis. A target UE may be specified like a DNN/S-NSSAI, a group ID, a UE list, etc., and a required synchronization accuracy may be indicated with a sync error budget. A supported domain or the like may also be specified.

In operation 2, the TSCTSF may send a request to the AMF to report current UEs that satisfy the conditions received in operation 1 and updated information when there is a change.

In operation 3, the AMF may report UEs that satisfy the conditions received in operation 2 to the TSCTSF. Furthermore, when there is a change, this may be notified to the TSCTSF again. With this, the TSCTSF may figure out the number of UEs that satisfy the conditions of operation 1.

In operation 2a, the TSCTSF may request a UDR/UDM to report PDU sessions and current UEs that satisfy the conditions received in operation 1 and updated information when there is a change.

In operation 3a, the UDR/UDM may report PDU sessions and UEs that satisfy the conditions received in operation 2a to the TSCTSF. Furthermore, when there is a change, this may be notified to the TSCTSF again. With this, the TSCTSF may figure out the number of UEs that satisfy the conditions of operation 1.

In an embodiment, the conditions of the request received in operation 1 is stored in the UDR in operation 2a, and when a new PDU session is created, content thereof is notified to a PCF, and association between the PCF and the TSCTSF/NEF is then performed, thereby enabling information delivery.

Furthermore, while associating with the AMF, when there is a change in information corresponding to an AM policy, the PCF may request the UDR to report the changed content.

In operation 4, the TSCTSF/NEF may send the AF a response to the request of operation 1.

In operation 5, the TSCTSF/NEF may determine whether to use NAS or AS. This may enable reduction in use of unnecessary 5GS internal resources. In a case that there is only a low accuracy sync requirement, the TSCTSF/NEF may switch an AS request to an NAS request to maintain SIB delivery frequency low. Furthermore, the TSCTSF/NEF may deliver a signal only to particular UEs by sending the NAS request instead of the AS request that is broadcast to the whole UEs when there are a small number of UEs. When a high accuracy that may not be attained with the NAS sync request is required, the TSCTSF/NEF may switch to the AS sync to increase the entire SIB delivery frequency or further increase timing advance measurement frequency through RRC to the UE.

In a case of determining to send a sync request on an AS in operation 5, a sync request message may be sent to the PCF from the TSCTSF/NEF by the TSCTSF/NEF delivering information to the UDR and the UDR reporting the information to the PCF in operation 6. In this case, accuracy information such as the UE information and a sync error budget may be included in the information sent to the PCF from the TSCTSF/NEF.

In operation 6a, the TSCTSF/NEF may notify a processing result to the AF. In this case, information of the UEs and reflected sync request-restricted conditions may be included.

In operation 7, the PCF may transmit a message indicating that an AM policy has been updated to the AMF. This message may include the accuracy information such as the UE information and the sync error budget.

In operation 8, the AMF may notify a gNB that the UE's context has changed. In this case, the accuracy information such as the UE information and the sync error budget may be included.

In operation 9, the gNB may control SIB transmission frequency or frequency of measuring a timing advance value through RRC to the UE in accordance with the accuracy information such as the sync error budget.

In FIG. 6, the UE may get to support a sync accuracy controlled by an SIB or RRC, thereby being in a state of receiving the 5GS sync while satisfying the conditions requested by the AF in operation 1.

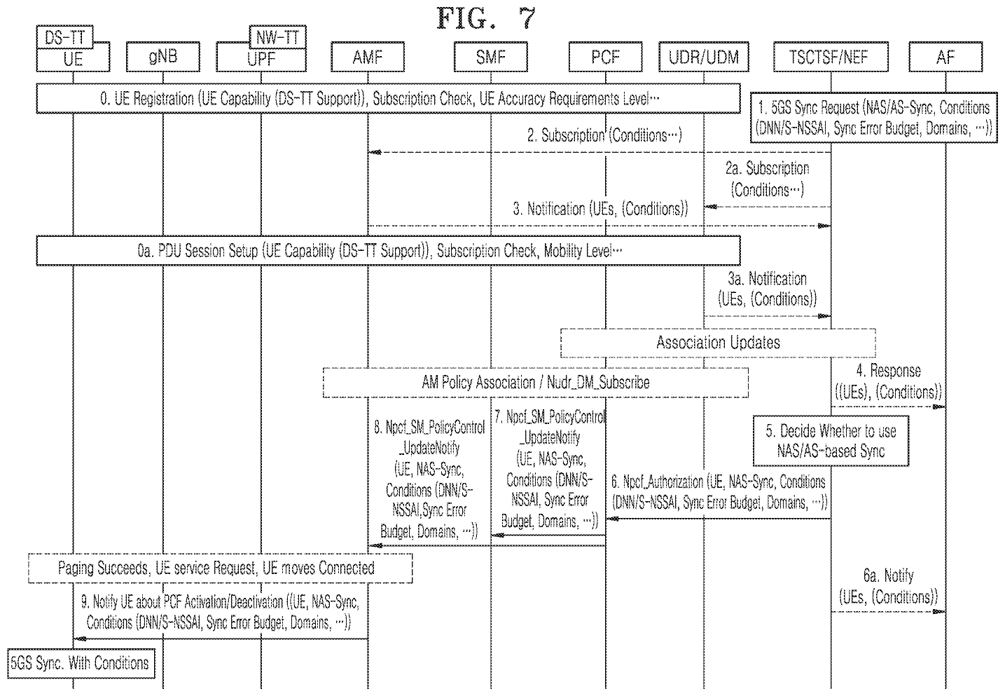

FIG. 7 is a sequence diagram illustrating a method for a TSCTSF/NEF to switch an AF request into a non-access stratum (NAS) basis to suit a 5GS situation and send the switched request, according to an embodiment of the disclosure.

Referring to FIG. 7, in operation 0, a UE may make registration, with information about whether to support a DS-TT, 5GS synchronization service subscription information, requirement accuracy information, UE mobility information, and the like. In this procedure, the information may be stored in an AMF and a UDM.

Furthermore, in operation 0, in setting up a PDU session, whether to support a DS-TT (e.g., DS-TT support), 5GS synchronization service subscription information (e.g., subscription check), UE mobility information, etc., may be included.

In operation 1, an AF may send a 5GS sync request to a TSCTSF through an NEF. In this case, it may be on an NAS basis or an AS basis. A target UE may be specified like a DNN/S-NSSAI, a group ID, a UE list, etc., and a required synchronization accuracy may be indicated with a sync error budget. A supported domain or the like may also be specified.

In operation 2, the TSCTSF may send a request to the AMF to report current UEs that satisfy the conditions received in operation 1 and updated information when there is a change.

In operation 3, the AMF may report UEs that satisfy the conditions received in operation 2 to the TSCTSF. Furthermore, when there is a change, this may be notified to the TSCTSF again. With this, the TSCTSF may figure out the number of the UEs that satisfy the conditions of operation 1.

In operation 2a, the TSCTSF may request a UDR/UDM to report PDU sessions and current UEs that satisfy the conditions received in operation 1 and updated information when there is a change.

In operation 3a, the UDR/UDM may report PDU sessions and UEs that satisfy the conditions received in operation 2a to the TSCTSF. Furthermore, when there is a change, this may be notified to the TSCTSF again. With this, the TSCTSF may figure out the number of the UEs that satisfy the conditions of operation 1.

In an embodiment, the conditions of the request received in operation 1 is stored in the UDR in operation 2a, and when a new PDU session is created, content thereof is notified to a PCF, and association between the PCF and the TSCTSF/NEF is then performed, thereby enabling information delivery.

In operation 4, the TSCTSF/NEF may send the AF a response to the request of operation 1.

In operation 5, the TSCTSF/NEF may determine whether to use NAS or AS. This may enable reduction in use of unnecessary 5GS internal resources. In a case that there is only a low accuracy sync requirement, the TSCTSF/NEF may switch the AS request to an NAS request to maintain SIB delivery frequency low. Furthermore, the TSCTSF/NEF may deliver a signal only to particular UEs by sending the NAS request instead of the AS request that is broadcast to the whole UEs when there are a small number of UEs. When a high accuracy that may not be attained with the NAS sync request is required, the TSCTSF/NEF may switch to the AS sync to increase the entire SIB delivery frequency or further increase timing advance measurement frequency through RRC to the UE.

In a case of determining to send a sync request on an NAS in operation 5, the TSCTSF/NEF may send a sync request message to the PCF in operation 6. In this case, the accuracy information such as the UE information and the sync error budget may be included. Furthermore, port management information for a sync support method using IEEE 802.1AS or IEEE1588 such as a DNN/S-NSSAI, a domain, etc., may be included.

In operation 6a, the TSCTSF/NEF may notify a processing result to the AF. In this case, information of the UEs and reflected sync request-restricted conditions may be included.

In operation 7, the PCF may transmit a message indicating that an SM policy has been updated to the SMF. In this case, the accuracy information such as the UE information and the sync error budget may be included. Furthermore, port management information for a sync support method using IEEE 802.1AS or IEEE1588 such as a DNN/S-NSSAI, a domain, etc., may be included.

In operation 8, the SMF may send a message to the AMF to deliver PDU session update information for the UE. In this case, the accuracy information such as the UE information and the sync error budget may be included. Furthermore, port management information for a sync support method using IEEE 802.1AS or IEEE1588 such as a DNN/S-NSSAI, a domain, etc., may be included.

In operation 9, the AMF may send a message to the UE via the gNB by using a PDU session update procedure. In this case, the accuracy information such as the UE information and the sync error budget may be included. Furthermore, port management information for a sync support method using IEEE 802.1AS or IEEE1588 such as a DNN/S-NSSAI, a domain, etc., may be included.

When the UE is in an idle mode in operation 8, paging may be proceeded for the UE, and after the UE having received a paging message is switched into a connected mode by sending a service request to the gNB, operation 9 may be proceeded.

In FIG. 7, the UE may go into a state of receiving the 5GS sync while satisfying the conditions requested by the AF in operation 1.

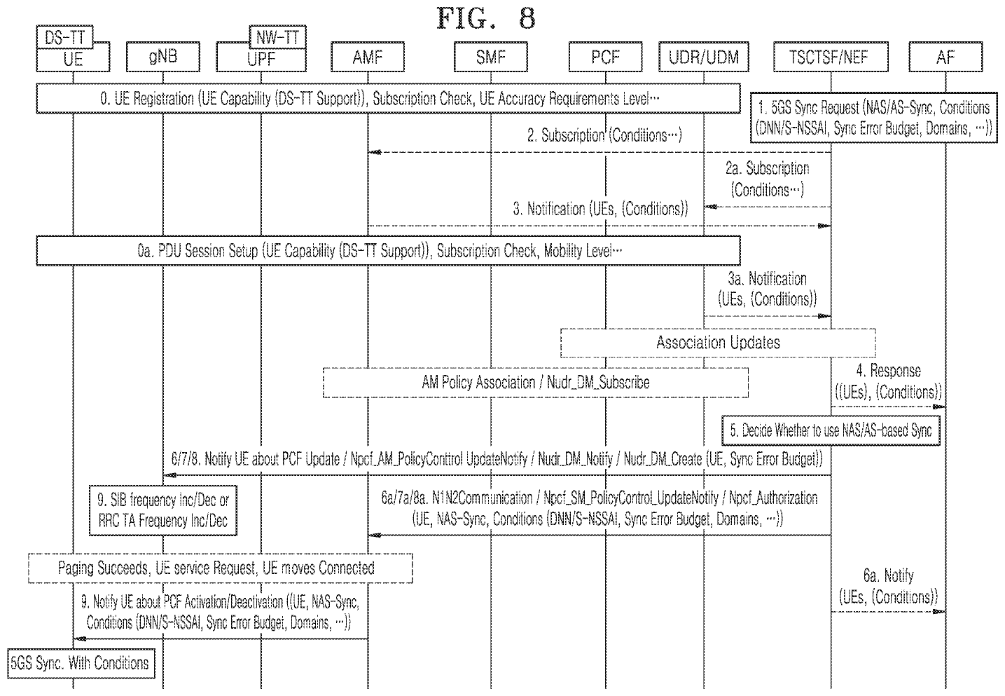

FIG. 8 is a sequence diagram illustrating a method for a TSCTSF/NEF to switch an AF request into an AS and NAS basis to suit a 5GS situation and send the switched request, according to an embodiment of the disclosure.

Referring to FIG. 8, in operation 0, a UE may make registration, with information about whether to support a DS-TT, 5GS synchronization service subscription information, requirement accuracy information, UE mobility information, and the like. In this procedure, the information may be stored in an AMF and a UDM.

Furthermore, in operation 0, in setting up a PDU session, whether to support a DS-TT (e.g., DS-TT support), 5GS synchronization service subscription information (e.g., subscription check), UE mobility information, etc., may be included.

In operation 1, an AF may send a 5GS sync request to a TSCTSF through an NEF. In this case, it may be on an NAS basis or an AS basis. A target UE may be specified like a DNN/S-NSSAI, a group ID, a UE list, etc., and a required synchronization accuracy may be indicated with a sync error budget. A supported domain or the like may also be specified.

In operation 2, the TSCTSF may send a request to the AMF to report current UEs that satisfy the conditions received in operation 1 and updated information when there is a change.

In operation 3, the AMF may report UEs that satisfy the conditions received in operation 2 to the TSCTSF. Furthermore, when there is a change, this may be notified to the TSCTSF again. With this, the TSCTSF may figure out the number of UEs that satisfy the conditions of operation 1.

In operation 2a, the TSCTSF may request a UDR/UDM to report PDU sessions and current UEs that satisfy the conditions received in operation 1 and updated information when there is a change.

In operation 3a, the UDR/UDM may report PDU sessions and UEs that satisfy the conditions received in operation 2a to the TSCTSF. Furthermore, when there is a change, this may be notified to the TSCTSF again. With this, the TSCTSF may figure out the number of UEs that satisfy the conditions of operation 1.

In an embodiment, the conditions of the request received in operation 1 is stored in the UDR in operation 2a, and when a new PDU session is created, content thereof is notified to a PCF, and association between the PCF and the TSCTSF/NEF is then performed, thereby enabling information delivery.

Furthermore, while associating with the AMF, when there is a change in information corresponding to an AM policy, the PCF may request the UDR to report the changed content.

In operation 4, the TSCTSF/NEF may send the AF a response to the request of operation 1.

In operation 5, the TSCTSF/NEF may determine whether to use NAS or AS. This may enable reduction in use of unnecessary 5GS internal resources. In a case that there is only a low accuracy sync requirement, the TSCTSF/NEF may change the AS request to an NAS request to maintain SIB delivery frequency low. Furthermore, the TSCTSF/NEF may deliver a signal only to particular UEs by sending the NAS request instead of the AS request that is broadcast to the whole UEs when there are a small number of UEs. When a high accuracy that may not be attained with the NAS sync request is required, the TSCTSF/NEF may switch to the AS sync to increase the entire SIB delivery frequency or further increase timing advance measurement frequency through RRC to the UE.

In operation 5, in a case of determining to send a sync request on both the AS and the NAS, the operations are as follows.

In operation 6, a sync request message may be sent to the PCF from the TSCTSF/NEF by the TSCTSF/NEF delivering information to the UDR and the UDR reporting the information to the PCF. In this case, the accuracy information such as the UE information and the sync error budget may be included.

In operation 7, the PCF may transmit a message indicating that an AM policy has been updated to the AMF. The message may include the accuracy information such as the UE information and the sync error budget.

In operation 8, the AMF may notify a gNB that the UE's context has changed. In this case, the accuracy information such as the UE information and the sync error budget may be included.

In operation 9, the gNB may control SIB transmission frequency or frequency of measuring a timing advance value through RRC to the UE in accordance with the accuracy information such as the sync error budget.

In operation 6a, the TSCTSF/NEF may send the sync request message to the PCF. In this case, the accuracy information such as the UE information and the sync error budget may be included. Furthermore, port management information for a sync support method using IEEE 802.1AS or IEEE1588 such as a DNN/S-NSSAI, a domain, etc., may be included.

In operation 6b, the TSCTSF/NEF may notify a processing result to the AF. In this case, information of the UEs and reflected sync request-restricted conditions may be included.

In operation 7a, the PCF may transmit a message indicating that an SM policy has been updated to the SMF. In this case, the accuracy information such as the UE information and the sync error budget may be included. Furthermore, port management information for a sync support method using IEEE 802.1AS or IEEE1588 such as a DNN/S-NSSAI, a domain, etc., may be included.

In operation 8a, the SMF may send a message to the AMF to deliver PDU session update information for the UE. In this case, the accuracy information such as the UE information and the sync error budget may be included. Furthermore, port management information for a sync support method using IEEE 802.1AS or IEEE1588 such as a DNN/S-NSSAI, a domain, etc., may be included.

In operation 9a, the AMF may send a message to the UE via the gNB by using a PDU session update procedure. In this case, the accuracy information such as the UE information and the sync error budget may be included. Furthermore, port management information for a sync support method using IEEE 802.1AS or IEEE1588 such as a DNN/S-NSSAI, a domain, etc., may be included.

When the UE is in an idle mode in operation 8a, paging may be proceeded for the UE, and after the UE having received a paging message is switched into a connected mode by sending a service request to the gNB, operation 9a may be proceeded.

In FIG. 8, the UE may go into a state of receiving the 5GS sync while satisfying the conditions requested by the AF in operation 1.

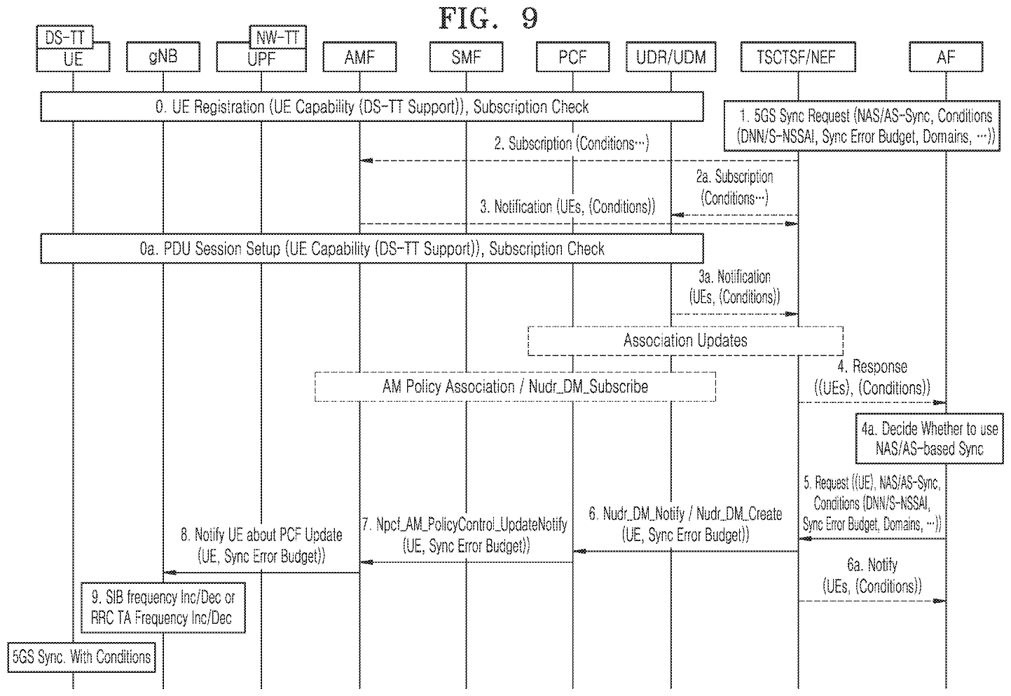

FIG. 9 is a sequence diagram illustrating a method for an AF to see a 5GS situation and perform delivery by switching into an AS basis to suit the 5GS situation, according to an embodiment of the disclosure.

Referring to FIG. 9, in operation 0, a UE may make registration, with information about whether to support a DS-TT, 5GS synchronization service subscription information, requirement accuracy information, UE mobility information, and the like. In this procedure, the information may be stored in an AMF and a UDM.

Furthermore, in operation 0, in setting up a PDU session, whether to support a DS-TT (e.g., DS-TT support), 5GS synchronization service subscription information (e.g., subscription check), UE mobility information, etc., may be included.

In operation 1, an AF may send a 5GS sync request to a TSCTSF through an NEF. In this case, the request may be sent on an NAS basis or an AS basis. A target UE may be specified like a DNN/S-NSSAI, a group ID, a UE list, etc., and a required synchronization accuracy may be indicated with a sync error budget. A supported domain or the like may also be specified.

In operation 2, the TSCTSF may send a request to the AMF to report current UEs that satisfy the conditions received in operation 1 and updated information when there is a change.

In operation 3, the AMF may report UEs that satisfy the conditions received in operation 2 to the TSCTSF. Furthermore, when there is a change, this may be notified to the TSCTSF again. With this, the TSCTSF may identify the number of the UEs that satisfy the conditions of operation 1.

In operation 2a, the TSCTSF may request a UDR/UDM to report PDU sessions and current UEs that satisfy the conditions received in operation 1 and updated information when there is a change.

In operation 3a, the UDR/UDM may report PDU sessions and UEs that satisfy the conditions received in operation 2a to the TSCTSF. Furthermore, when there is a change, this may be notified to the TSCTSF again. With this, the TSCTSF may identify the number of the UEs that satisfy the conditions of operation 1.

In an embodiment, the conditions of the request received in operation 1 is stored in the UDR in operation 2a, and when a new PDU session is created, content thereof is notified to a PCF, and association between the PCF and the TSCTSF/NEF is then performed, thereby enabling information delivery.

Furthermore, while associating with the AMF, when there is a change in information corresponding to an AM policy, the PCF may request the UDR to report the changed content.

In operation 4, the TSCTSF/NEF may send the AF a response to the request of operation 1.

In operation 4a, the AF may determine whether to use NAS or AS. This may enable reduction in use of unnecessary 5GS internal resources. In a case that there is only a low accuracy sync requirement, the AF may switch the AS request to an NAS request to maintain SIB delivery frequency low. Furthermore, the AF may deliver a signal only to particular UEs by sending the NAS request instead of the AS request that is broadcast to the whole UEs when there are a small number of UEs. When a high accuracy that may not be attained with the NAS sync request is required, the AF may switch to the AS sync to increase the entire SIB delivery frequency or further increase timing advance measurement frequency through RRC to the UE.

In operation 5, the AF may send the TSCTSF/NEF a new request including whether to use NAS or AS as determined in operation 4a.

In a case that the new request to deliver a sync request on the AS is delivered to the TSCTSF/NEF in operation 5, a sync request message may be sent to the PCF from the TSCTSF/NEF by the TSCTSF/NEF delivering information to the UDR and the UDR reporting the information to the PCF in operation 6. In this case, the accuracy information such as the UE information and the sync error budget may be included.

In operation 6a, the TSCTSF/NEF may notify a processing result to the AF. In this case, information of the UEs and reflected sync request-restricted conditions may be included.

In operation 7, the PCF may transmit a message indicating that an AM policy has been updated to the AMF. The message may include the accuracy information such as the UE information and the sync error budget.

In operation 8, the AMF may notify a gNB that the UE's context has changed. In this case, the accuracy information such as the UE information and the sync error budget may be included.

In operation 9, the gNB may control SIB transmission frequency or frequency of measuring a timing advance value through RRC to the UE in accordance with the accuracy information such as the sync error budget.

In FIG. 9, the UE may get to support a sync accuracy controlled by an SIB or RRC, thereby being in a state of receiving the 5GS sync while satisfying the conditions requested by the AF in operation 1.

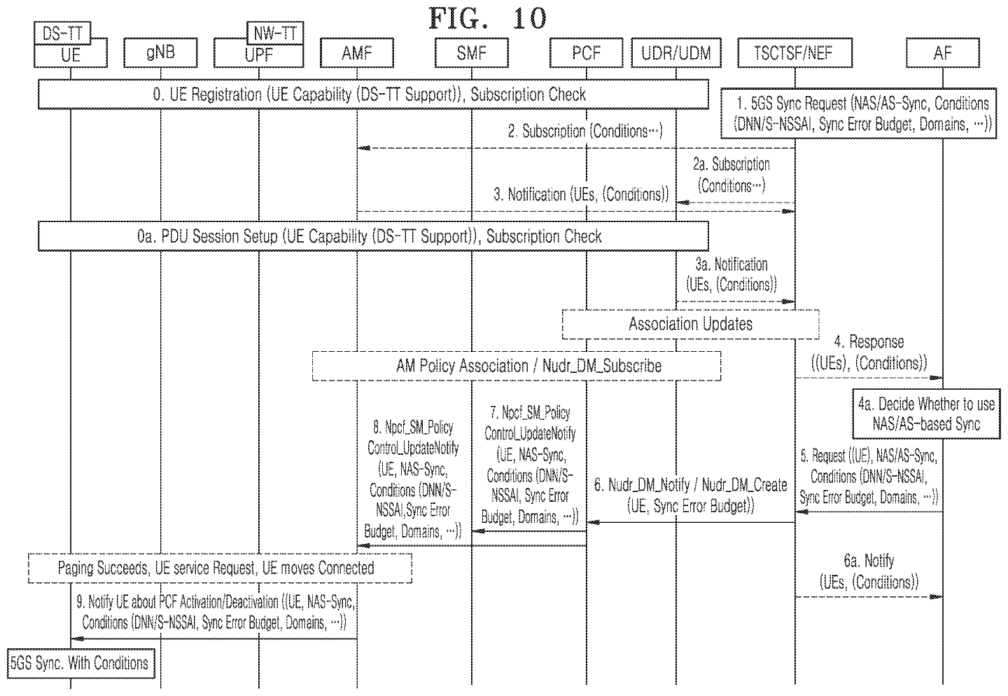

FIG. 10 is a sequence diagram illustrating a method for an AF to see a 5GS situation and perform delivery by switching into an NAS basis to suit the 5GS situation, according to an embodiment of the disclosure.

Referring to FIG. 10, in operation 0, a UE may make registration, with information about whether to support a DS-TT, 5GS synchronization service subscription information, requirement accuracy information, UE mobility information, and the like. In this procedure, the information may be stored in an AMF and a UDM.

Furthermore, in operation 0, in setting up a PDU session, whether to support a DS-TT (e.g., DS-TT support), 5GS synchronization service subscription information (e.g., subscription check), UE mobility information, etc., may be included.

In operation 1, an AF may send a 5GS sync request to a TSCTSF through an NEF. In this case, it may be on an NAS basis or an AS basis. A target UE may be specified like a DNN/S-NSSAI, a group ID, a UE list, etc., and a required synchronization accuracy may be indicated with a sync error budget. A supported domain or the like may also be specified.

In operation 2, the TSCTSF may send a request to the AMF to report current UEs that satisfy the conditions received in operation 1 and updated information when there is a change.

In operation 3, the AMF may report UEs that satisfy the conditions received in operation 2 to the TSCTSF. Furthermore, when there is a change, this may be notified to the TSCTSF again. With this, the TSCTSF may figure out the number of the UEs that satisfy the conditions of operation 1.

In operation 2a, the TSCTSF may request a UDR/UDM to report PDU sessions and current UEs that satisfy the conditions received in operation 1 and updated information when there is a change.

In operation 3a, the UDR/UDM may report PDU sessions and UEs that satisfy the conditions received in operation 2a to the TSCTSF. Furthermore, when there is a change, this may be notified to the TSCTSF again. With this, the TSCTSF may figure out the number of the UEs that satisfy the conditions of operation 1.

In an embodiment, the conditions of the request received in operation 1 is stored in the UDR in operation 2a, and when a new PDU session is created, content thereof is notified to a PCF, and association between the PCF and the TSCTSF/NEF is then performed, thereby enabling information delivery.

In operation 4, the TSCTSF/NEF may send the AF a response to the request of operation 1.

In operation 4a, the AF may determine whether to use NAS or AS. This may enable reduction in use of unnecessary 5GS internal resources. In a case that there is only a low accuracy sync requirement, the AF may switch an AS request to an NAS request to maintain SIB delivery frequency low. Furthermore, the AF may deliver a signal only to particular UEs by sending the NAS request instead of the AS request that is broadcast to the whole UEs when there are a small number of UEs. When a high accuracy that may not be attained with the NAS sync request is required, the AF may switch to the AS sync to increase the entire SIB delivery frequency or further increase timing advance measurement frequency through RRC to the UE.

In operation 5, the AF may send the TSCTSF/NEF a new request including whether to use NAS or AS as determined in operation 4a.

In a case that the new request to deliver the sync request on an NAS is delivered to the TSCTSF/NEF in operation 5, the TSCTSF/NEF may send a sync request message to the PCF. In this case, the accuracy information such as the UE information and the sync error budget may be included. Furthermore, port management information for a sync support method using IEEE 802.1AS or IEEE1588 such as a DNN/S-NSSAI, a domain, etc., may be included.

In operation 6a, the TSCTSF/NEF may notify a processing result to the AF. In this case, information of the UEs and reflected sync request-restricted conditions may be included.

In operation 7, the PCF may transmit a message indicating that an SM policy has been updated to the SMF. In this case, the accuracy information such as the UE information and the sync error budget may be included. Furthermore, port management information for a sync support method using IEEE 802.1AS or IEEE1588 such as a DNN/S-NSSAI, a domain, etc., may be included.

In operation 8, the SMF may send a message to the AMF to deliver PDU session update information for the UE. In this case, the accuracy information such as the UE information and the sync error budget may be included. Furthermore, port management information for a sync support method using IEEE 802.1AS or IEEE1588 such as a DNN/S-NSSAI, a domain, etc., may be included.

In operation 9, the AMF may send a message to the UE via the gNB by using a PDU session update procedure. In this case, the accuracy information such as the UE information and the sync error budget may be included. Furthermore, port management information for a sync support method using IEEE 802.1AS or IEEE1588 such as a DNN/S-NSSAI, a domain, etc., may be included.

When the UE is in an idle mode in operation 8, paging may be proceeded for the UE, and after the UE having received a paging message is switched into a connected mode by sending a service request to the gNB, operation 9 may be proceeded.

In FIG. 9, the UE may go into a state of receiving the 5GS sync while satisfying the conditions requested by the AF in operation 1.

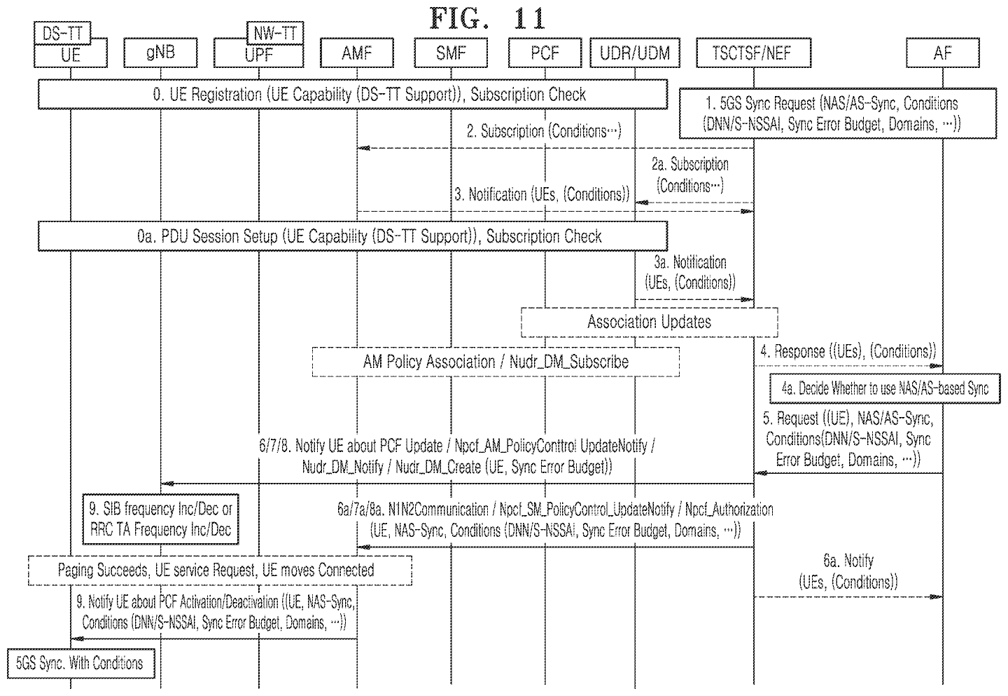

FIG. 11 is a sequence diagram illustrating a method for an AF to see a 5GS situation and perform delivery by switching into an AS and NAS basis to suit the 5GS situation.

Referring to FIG. 11, in operation 0, the UE may make registration, with information about whether to support a DS-TT, 5GS synchronization service subscription information, requirement accuracy information, UE mobility information, and the like. In this procedure, the information may be stored in an AMF and a UDM.

Furthermore, in operation 0, in setting up a PDU session, whether to support a DS-TT (e.g., DS-TT support), 5GS synchronization service subscription information (e.g., subscription check), UE mobility information, etc., may be included.

In operation 1, an AF may send a 5GS sync request to a TSCTSF through an NEF. In this case, it may be on an NAS basis or an AS basis. A target UE may be specified like a DNN/S-NSSAI, a group ID, a UE list, etc., and a required synchronization accuracy may be indicated with a sync error budget. A supported domain or the like may also be specified.

In operation 2, the TSCTSF may send a request to the AMF to report current UEs that satisfy the conditions received in operation 1 and updated information when there is a change.

In operation 3, the AMF may report UEs that satisfy the conditions received in operation 2 to the TSCTSF. Furthermore, when there is a change, this may be notified to the TSCTSF again. With this, the TSCTSF may figure out the number of the UEs that satisfy the conditions of operation 1.

In operation 2a, the TSCTSF may request a UDR/UDM to report PDU sessions and current UEs that satisfy the conditions received in operation 1 and updated information when there is a change.

In operation 3a, the UDR/UDM may report PDU sessions and UEs that satisfy the conditions received in operation 2a to the TSCTSF. Furthermore, when there is a change, this may be notified to the TSCTSF again. With this, the TSCTSF may figure out the number of the UEs that satisfy the conditions of operation 1.

In an embodiment, the conditions of the request received in operation 1 is stored in the UDR in operation 2a, and when a new PDU session is created, content thereof is notified to a PCF, and association between the PCF and the TSCTSF/NEF is then performed, thereby enabling information delivery.

Furthermore, while associating with the AMF, when there is a change in information corresponding to an AM policy, the PCF may request the UDR to report the changed content.

In operation 4, the TSCTSF/NEF may send the AF a response to the request of operation 1.

In operation 4a, the AF may determine whether to use NAS or AS. This may enable reduction in use of unnecessary 5GS internal resources. In a case that there is only a low accuracy sync requirement, the AF may switch the AS request to an NAS request to maintain SIB delivery frequency low. Furthermore, the AF may deliver a signal only to particular UEs by sending the NAS request instead of the AS request that is broadcast to the whole UEs when there are a small number of UEs. When a high accuracy that may not be attained with the NAS sync request is required, the AF may switch to the AS sync to increase the entire SIB delivery frequency or further increase timing advance measurement frequency through RRC to the UE.

In operation 5, the AF may send the TSCTSF/NEF a new request including whether to use NAS or AS as determined in operation 4a.

In operation 5, in a case that a new request to send a sync request on the AS and NAS is delivered to the TSCTSF/NEF, operations will be as follows.

In operation 6, a sync request message may be sent to the PCF from the TSCTSF/NEF by the TSCTSF/NEF delivering information to the UDR and the UDR reporting the information to the PCF. In this case, the accuracy information such as the UE information and the sync error budget may be included.

In operation 7, the PCF may transmit a message indicating that an AM policy has been updated to the AMF. The message may include the accuracy information such as the UE information and the sync error budget.

In operation 8, the AMF may notify a gNB that the UE's context has changed. In this case, the accuracy information such as the UE information and the sync error budget may be included.

In operation 9, the gNB may control SIB transmission frequency or frequency of measuring a timing advance value through RRC to the UE in accordance with the accuracy information such as the sync error budget.

In operation 6a, the TSCTSF/NEF may send the sync request message to the PCF. In this case, the accuracy information such as the UE information and the sync error budget may be included. Furthermore, port management information for a sync support method using IEEE 802.1AS or IEEE1588 such as a DNN/S-NSSAI, a domain, etc., may be included.

In operation 6b, the TSCTSF/NEF may notify a processing result to the AF. In this case, information of the UEs and reflected sync request-restricted conditions may be included.

In operation 7a, the PCF may transmit a message indicating that an SM policy has been updated to the SMF. In this case, the accuracy information such as the UE information and the sync error budget may be included. Furthermore, port management information for a sync support method using IEEE 802.1AS or IEEE1588 such as a DNN/S-NSSAI, a domain, etc., may be included.

In operation 8a, the SMF may send a message to the AMF to deliver PDU session update information for the UE. In this case, the accuracy information such as the UE information and the sync error budget may be included. Furthermore, port management information for a sync support method using IEEE 802.1AS or IEEE1588 such as a DNN/S-NSSAI, a domain, etc., may be included.

In operation 9a, the AMF may send a message to the UE via the gNB by using a PDU session update procedure. In this case, the accuracy information such as the UE information and the sync error budget may be included. Furthermore, port management information for a sync support method using IEEE 802.1AS or IEEE1588 such as a DNN/S-NSSAI, a domain, etc., may be included.

In operation 8a, when the UE is in an idle mode, paging may be proceeded for the UE. After the UE having received a paging message is switched into a connected mode by sending a service request to the gNB, operation 9a may be proceeded.

In FIG. 11, the UE may go into a state of receiving the 5GS sync while satisfying the conditions requested by the AF in operation 1.

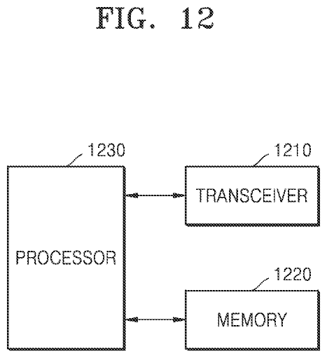

FIG. 12 is a block diagram illustrating a configuration of a terminal (or UE), according to an embodiment of the disclosure.

Referring to FIG. 12, the UE may include a processor 1230, a transceiver 1210, and a memory 1220. Components of the UE are not, however, limited thereto. For example, the UE may include more or fewer elements than described above. In addition, the processor 1230, the transceiver 1210 and the memory 1220 may be implemented in the form of a single chip.

In an embodiment, the processor 1230 may control a series of processes for the UE to be operated according to the aforementioned embodiments of the disclosure. For example, it may control the components of the UE to perform a method of providing synchronization in a wireless communication system according to an embodiment of the disclosure. The processor 1230 may be provided in the plural, which may perform the operation of providing synchronization in the wireless communication system as described above by carrying out a program stored in the memory 1220.

The transceiver 1210 may transmit or receive signals to or from a BS (or gNB). The signals to be transmitted to or received from the BS may include control information and data. The transceiver 1210 may include an RF transmitter for up-converting the frequency of a signal to be transmitted and amplifying the signal and an RF receiver for low-noise amplifying a received signal and down-converting the frequency of the received signal. It is merely an example, and the elements of the transceiver 1210 are not limited to the RF transmitter and RF receiver. In addition, the transceiver 1210 may receive a signal on a wireless channel and output the signal to the processor 1230, and transmit a signal output from the processor 1230 on a wireless channel.

In an embodiment, the memory 1220 may store a program and data required for operation of the UE. Furthermore, the memory 1220 may store control information or data included in a signal transmitted or received by the UE. The memory 1220 may include a storage medium such as a read only memory (ROM), a random-access memory (RAM), a hard disk, a compact disc ROM (CD-ROM), and a digital versatile disk (DVD), or a combination of storage mediums. Moreover, the memory 1220 may be provided in the plural. In an embodiment, the memory 1220 may store a program for operations of providing synchronization in a wireless communication system as described above.

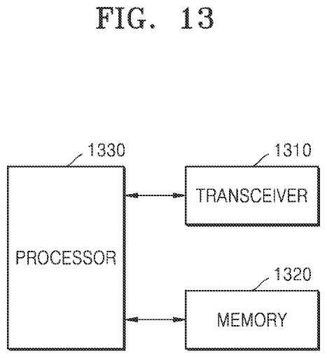

FIG. 13 is a block diagram illustrating a configuration of a BS (or gNB), according to an embodiment of the disclosure.

Referring to FIG. 13, the BS may include a processor 1330, a transceiver 1310, and a memory 1320. Components of the BS are not, however, limited thereto. For example, the BS may include more or fewer elements than described above. In addition, the processor 1330, the transceiver 1310, and the memory 1320 may be implemented in a single chip.

The processor 1330 may control a series of processes for the BS to be operated according to the embodiments of the disclosure. For example, it may control the components of the BS to perform a method of providing synchronization in a wireless communication system according to embodiments of the disclosure. The processor 1330 may be provided in the plural, which may perform the method of providing synchronization in the wireless communication system as described above by carrying out a program stored in the memory 1320.

The transceiver 1310 may transmit or receive signals to or from a UE. The signals to be transmitted to or received from the UE may include control information and data. The transceiver 1310 may include an RF transmitter for up-converting the frequency of a signal to be transmitted and amplifying the signal and an RF receiver for low-noise amplifying a received signal and down-converting the frequency of the received signal. It is merely an example, and the elements of the transceiver 1310 are not limited to the RF transmitter and RF receiver. In addition, the transceiver 1310 may receive a signal on a wireless channel and output the signal to the processor 1330, and transmit a signal output from the processor 1330 on a wireless channel.

In an embodiment, the memory 1320 may store a program and data required for operation of the BS. Furthermore, the memory 1320 may store control information or data included in a signal transmitted or received by the BS. The memory 1320 may include a storage medium such as a ROM, a RAM, a hard disk, a CD-ROM, and a DVD, or a combination of storage mediums. Moreover, the memory 1320 may be in the plural. In an embodiment, the memory 1320 may store a program to perform the method of providing synchronization in a wireless communication system in the aforementioned embodiments of the disclosure.

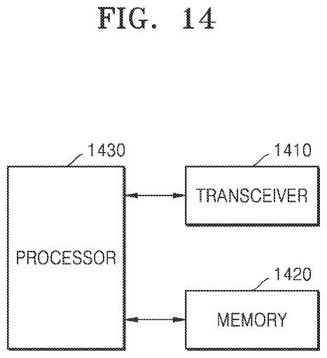

FIG. 14 is a block diagram of a core network entity in a wireless communication system, according to an embodiment of the disclosure. “Unit”, “module”, “block”, etc., as used herein each represent a unit for handling at least one function or operation, and may be implemented in hardware, software, or a combination thereof.

Referring to. 14, the core network object may include a transceiver 1410, a memory 1420, and a processor 1430.

The transceiver 1410 may provide an interface for communicating with other devices in the network. Specifically, the transceiver 1410 may convert a bitstream to be transmitted to another device from the core network object into a physical signal and convert a physical signal received from the other device into a bitstream. That is, the transceiver 1410 may transmit or receive a signal. Hence, the transceiver 1410 may also be referred to as a modem, a transmitter, a receiver, a communication unit, or a communication module. In this case, the transceiver 1410 may allow the core network object to communicate with other devices or systems through backhaul connection (e.g., wired backhaul or wireless backhaul) or other connection methods, or over a network.

The memory 1420 may store a basic program for operation of the core network object, an application program, and data such as settings information. The memory 1420 may include a volatile memory, a non-volatile memory, or a combination of the volatile memory and the non-volatile memory. The memory 1420 may also provide the stored data at the request of the processor 1430.

The processor 1430 may control general operation of the core network object. For example, the processor 1430 may transmit or receive a signal through the transceiver 1410. The processor 1430 may record data to the memory 1420 or read out data from the memory 1020. For this, the processor 1430 may include at least one processor. The processor 1430 may control the core network entity to perform operations according to the following various embodiments of the disclosure. For example, it may control components of the core network entity to perform the method of providing synchronization in a wireless communication system according to the disclosure.

Methods according to the claims of the disclosure or the embodiments of the disclosure described in the specification may be implemented in hardware, software, or a combination of hardware and software.

When implemented in software, a computer-readable storage medium or computer program product storing one or more programs (software modules) may be provided. The one or more programs stored in the computer-readable storage medium or computer program product are configured for execution by one or more processors in an electronic device. The one or more programs may include instructions that cause the electronic device to perform the methods in accordance with the claims of the disclosure or the embodiments described in the specification.

The programs (software modules, software) may be stored in a RAM, a non-volatile memory including a flash memory, a ROM, an electrically erasable programmable ROM (EEPROM), a magnetic disc storage device, a CD-ROM, a DVD or other types of optical storage device, and/or a magnetic cassette. Alternatively, the programs may be stored in a memory including a combination of some or all of them. There may be a plurality of memories.

The program may also be stored in an attachable storage device that may be accessed over a communication network including the Internet, an intranet, a local area network (LAN), a wide LAN (WLAN), or a storage area network (SAN), or a combination thereof. The storage device may be connected to an apparatus for performing the embodiments of the disclosure through an external port. Furthermore, an extra storage device in the communication network may access a device that performs the embodiments of the disclosure.

In the disclosure, the term ‘computer program product’ or ‘computer-readable recording medium’ is used to generally indicate a medium such as a memory, a hard disc installed in a hard disc drive, and a signal. The computer program product or computer-readable recording medium is a means provided for the method of providing synchronization in a wireless communication system according to the disclosure.

The machine-readable storage medium may be provided in the form of a non-transitory storage medium. The term ‘non-transitory storage medium’ may mean a tangible device without including a signal, e.g., electromagnetic waves, and may not distinguish between storing data in the storage medium semi-permanently and temporarily. For example, the non-transitory storage medium may include a buffer that temporarily stores data.

In an embodiment of the disclosure, the aforementioned method according to the various embodiments of the disclosure may be provided in a computer program product. The computer program product may be a commercial product that may be traded between a seller and a buyer. The computer program product may be distributed in the form of a machine-readable storage medium (e.g., a compact disc read only memory (CD-ROM)) or distributed directly between two user devices (e.g., smart phones) or online (e.g., downloaded or uploaded). In the case of the online distribution, at least part of the computer program product (e.g., a downloadable app) may be at least temporarily stored or arbitrarily created in a storage medium that may be readable to a device such as a server of the manufacturer, a server of the application store, or a relay server.

In the embodiments of the disclosure, a component is represented in a singular or plural form. It should be understood, however, that the singular or plural representations are selected appropriately according to the situations presented for convenience of explanation, and the disclosure is not limited to the singular or plural form of the component. Further, the component expressed in the plural form may also imply the singular form, and vice versa.

Several embodiments of the disclosure have been described, but a person of ordinary skill in the art will understand and appreciate that various modifications can be made without departing the scope of the disclosure. Thus, it will be apparent to those of ordinary skill in the art that the disclosure is not limited to the embodiments of the disclosure, which have been provided only for illustrative purposes. Furthermore, the embodiments may be operated by being combined with one another if necessary. For example, an embodiment of the disclosure and some of another embodiment of the disclosure may be combined to operate the BS and the UE. The embodiments of the disclosure may be equally applied to other communication systems, and other modifications of the embodiments may also be made without departing from the scope of the disclosure. For example, the embodiments of the disclosure may also be applied to an LTE system, 5G, an NR system, a 6G system, etc. Thus, it will be apparent to those ordinary skilled in the art that the disclosure is not limited to the embodiments described, but can encompass not only the appended claims but the equivalents.

1. A method of operating a time sensitive communication time synchronization function (TSCTSF) for providing synchronization in a wireless communication system, the method comprising:
receiving a request for time synchronization associated with a non-access stratum (NAS) from an application function (AF); and
transmitting access stratum (AS) based time synchronization information to a base station (BS) through a policy control function (PCF) based on the request for time synchronization associated with the NAS.

2. The method of claim 1, wherein the AS based time synchronization information comprises information about a first synchronization error budget.

3. The method of claim 1, wherein the request for time synchronization associated with the NAS comprises a request for a method of supporting synchronization based on IEEE 802.1AS or IEEE1588.

4. The method of claim 1, wherein the request for time synchronization associated with the NAS comprises at least one of information about a second synchronization error budget, information about a data network name (DNN), information about single-network slice selection assistance information (S-NSSAI), a group identity (ID), information about a domain or information about a UE list.

5. The method of claim 1, further comprising:
transmitting information about port management to a user equipment (UE) through the PCF.

6. A time sensitive communication time synchronization function (TSCTSF) for providing synchronization in a wireless communication system, the TSCTSF comprising:
a transceiver; and
at least one processor coupled with the transceiver,
wherein the at least one processor is configured to:
receive a request for time synchronization associated with a non-access stratum (NAS) from an application function (AF), and
transmit access stratum (AS) based time synchronization information to a base station (BS) through a policy control function (PCF) based on the request for time synchronization associated with the NAS.

7. The TSCTSF of claim 6, wherein the AS based time synchronization information comprises information about a first synchronization error budget.

8. The TSCTSF of claim 6, wherein the request for time synchronization associated with the NAS comprises a request for a method of supporting synchronization based on IEEE 802.1AS or IEEE1588.

9. The TSCTSF of claim 6, wherein the request for time synchronization associated with the NAS comprises at least one of information about a second synchronization error budget, information about a data network name (DNN), information about single-network slice selection assistance information (S-NSSAI), a group identity (ID), information about a domain or information about a UE list.

10. The TSCTSF of claim 6, wherein the at least one processor is configured to transmit information about port management to a user equipment (UE) through the PCF.

11. A method of operating a policy control function (PCF) for providing synchronization in a wireless communication system, the method comprising:
receiving access stratum (AS) based time synchronization information obtained based on a request for time synchronization associated with a non-access stratum (NAS) from a time sensitive communication time synchronization function (TSCTSF); and
transmitting information about a third synchronization error budget based on the AS based time synchronization information to a base station (BS) through an access and mobility management function (AMF),
wherein the AS based time synchronization information is obtained based on the request for time synchronization associated with the NAS.

12. The method of claim 11, further comprising:
receiving information about a port management from the TSCTSF; and
transmitting information about port management to a user equipment (UE) through a session management function (SMF).

13. The method of claim 11, wherein the AS based time synchronization information comprises information about a first synchronization error budget.

14. A policy control function (PCF) for providing synchronization in a wireless communication system, the PCF comprising:
a transceiver; and
at least one processor coupled with the transceiver,
wherein the at least one processor is configured to:
receive access stratum (AS) based time synchronization information obtained based on a request for time synchronization associated with a non-access stratum (NAS) from a time sensitive communication time synchronization function (TSCTSF), and
transmit information about a third synchronization error budget based on the AS based time synchronization information to a base station (BS) through an access and mobility management function (AMF).

15. The PCF of claim 14,
wherein the at least one processor is configured to:
receive information about a port management from the TSCTSF, and
transmit information about port management to a user equipment (UE) through a session management function (SMF), and
wherein the AS based time synchronization information is obtained based on the request for time synchronization associated with the NAS.
